(19) United States
(12) Patent Application Publication
(10) Pub. No.: US 2022/0284311 A1
(43) Pub. Date: Sep. 8, 2022

(54) Method and System for Generating In-Game Insights

(71) Applicant: STATS LLC, Chicago, IL (US)

(72) Inventors: Nicholas Haynes, Durham, NC (US); Michael Dillon, Durham, NC (US); Joseph Cody Braun, Durham, NC (US); Patrick Joseph Lucey, Chicago, IL (US)

(73) Assignee: STATS LLC, Chicago, IL (US)

(21) Appl. No.: 17/653,394

(22) Filed: Mar. 3, 2022

Related U.S. Application Data
(60) Provisional application No. 63/157,470, filed on Mar. 5, 2021.

(51) Int. Cl. G06N 5/02; G06N 20/20

(52) U.S. Cl. CPC G06N 5/02; G06N 20/20

(57) ABSTRACT

A computing system receives event data that includes play-by-play information for an event. The computing system accesses a database that includes a knowledge graph related to the event. The knowledge graph includes a plurality of nodes and a plurality of edges. Each node of the plurality of nodes represents a player or a team involved in the event. The plurality of edges connects nodes of the plurality of nodes. The computing system updates the knowledge graph based on the play-by-play information. The computing system generates, via a first machine learning model, one or more insights based on the updated knowledge graph. The computing system scores, via a second machine learning model, a score for each of the one or more insights. The computing system presents a highest ranking insight of the one or more insights to one or more end users.

### CROSS-REFERENCE TO RELATED APPLICATIONS

This application claims priority to U.S. Application Ser. No. 63/157,470, filed Mar. 5, 2021, which is hereby incorporated by reference in its entirety.

### FIELD OF THE DISCLOSURE

The present disclosure generally relates to system and method for generating, scoring, and presenting in-game insights to users, based on, for example, event data.

### BACKGROUND

Human analysts generate in-game commentary and analysis for major sports events based on a combination of their experience and research that is performed prior to the event. Given the time sensitivity and highly manual nature of this work, it is easy for important or interesting insights to be missed.

### SUMMARY

In some embodiments, a method is disclosed herein. A computing system receives event data. The event data includes play-by-play information for an event. The computing system accesses a database that includes a knowledge graph related to the event. The knowledge graph includes a plurality of nodes and a plurality of edges. Each node of the plurality of nodes represents a player or a team involved in the event. The plurality of edges connects nodes of the plurality of nodes. Each edge of the plurality of edges represents an action performed in the event. The computing system updates the knowledge graph based on the play-by-play information. The computing system generates, via a first machine learning model, one or more insights based on the updated knowledge graph. The computing system scores, via a second machine learning model, a score for each of the one or more insights. The computing system presents a highest ranking insight of the one or more insights to one or more end users.

In some embodiments, a system is disclosed herein. The system includes a processor and a memory. The memory includes programming instructions stored thereon, which, when executed by the processor, causes the system to perform operations. The operations include receiving event data. The event data includes play-by-play information for an event. The operations further include accessing a database that includes a knowledge graph related to the event. The knowledge graph includes a plurality of nodes and a plurality of edges. Each node of the plurality of nodes represents a player or a team involved in the event. The plurality of edges connects nodes of the plurality of nodes, wherein each edge of the plurality of edges represents an action performed in the event. The operations further include updating the knowledge graph based on the play-by-play information. The operations further include generating, via a first machine learning model, one or more insights based on the updated knowledge graph. The operations further include scoring, via a second machine learning model, a score for each of the one or more insights. The operations further include presenting a highest ranking insight of the one or more insights to one or more end users.

In some embodiments, a non-transitory computer readable medium is disclosed herein. The non-transitory computer readable medium includes one or more sequences of instructions that, when executed by one or more processors, causes a computing system to perform operations. The operations include receiving, by the computing system, event data. The event data includes play-by-play information for an event. The operations further include accessing, by the computing system, a database that includes a knowledge graph related to the event. The knowledge graph includes a plurality of nodes and a plurality of edges. Each node of the plurality of nodes represents a player or a team involved in the event. The plurality of edges connects nodes of the plurality of nodes, wherein each edge of the plurality of edges represents an action performed in the event. The operations further include updating, by the computing system, the knowledge graph based on the play-by-play information. The operations further include generating, by the computing system, via a first machine learning model, one or more insights based on the updated knowledge graph. The operations further include scoring, by the computing system, via a second machine learning model, a score for each of the one or more insights. The operations further include presenting, by the computing system, a highest ranking insight of the one or more insights to one or more end users.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating an exemplary knowledge graph, according to example embodiments.

FIG. 3 is a flow diagram illustrating a method of generating a fully trained insights generation and scoring models, according to example embodiments.

FIG. 4 is a flow diagram illustrating a method of generating, scoring, and presenting an insight to an end user, according to example embodiments.

FIG. 5A is a block diagram illustrating a computing device, according to example embodiments.

FIG. 5B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques disclosed herein generally relate to a system and method for generating in-game insights based on play-by-play event data. For example, one or more technique disclosed herein relate to a method of transforming live box score and play-by-play data from a team sports event into descriptive, written insights, and ranking those insights based on their relevance. A proof-of-concept system is disclosed herein that is used to generate text-based insights during sports events.

As provided above, current methods of producing in-game insights are reliant on human analysis parsing through event data and identifying those insights that may be relevant and/or interesting. Such manual process may not only be highly time consuming, but may also result in human analysts missing key insights. Further, human analysts may also spend their limited time and attention during a live event producing a combination of formulaic, repetitive insights and deeper, more meaningful insights, which may distract human analysts from the actual event.

Insights generated based on static rules may alleviate some of these problems. The same analysts who generate in-game insights may identify specific instances that would deterministically trigger a given insight. For example, when a running back gains 100 yards rushing in an NFL game or a player scores 30 points in an NBA game. The logic for triggering these insights can then be implemented by a database administrator or software engineering team. This process may eliminate some of the formulaic insight generation work of the analysts during live events, and has the advantage of having a low false positive rate; it fails, however, in solving the problem of identifying key insights that the analyst has not identified.

The present system eliminates this burden on human analysts and improves upon conventional static rule-based approaches by automating the more formulaic insights, thereby allowing the human analysts to focus entirely on producing more in-depth insights, thus increasing the overall quality of analysis presented to fans.

The present system may be implemented without human intervention to produce insights that are presented directly to fans during games for which there is no human analyst support. These insights may not be as in-depth as those produced by humans during major events, but nevertheless, will provide significant value over not having any live insights.

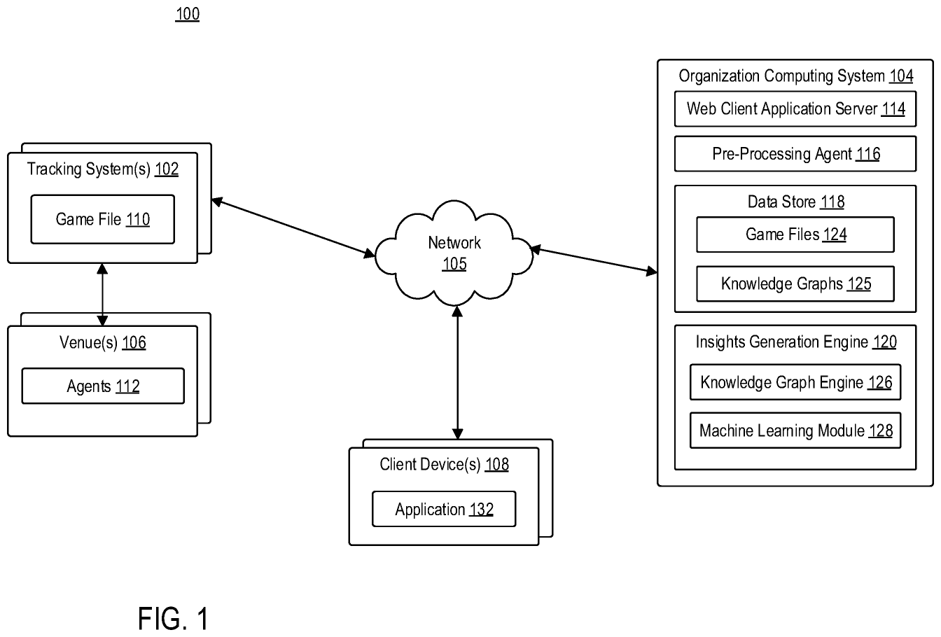

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to record the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In some embodiments, tracking system 102 may be a radio-based system using, for example, radio frequency identification (RFID) tags worn by players or embedded in objects to be tracked. Generally, tracking system 102 may be configured to sample and record, at a high frame rate (e.g., 25 Hz). Tracking system 102 may be configured to store at least player identity and positional information (e.g., (x,y) position) for all agents and objects on the playing surface for each frame in a game file 110. For example, tracking system 102 may be configured to store play-by-play data for a given event in game file 110.

Game file 110 may be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102. Organization computing system 104 may include at least a web client application server 114, a pre-processing agent 116, a data store 118, and insights generation engine 120. Each of pre-processing agent 116 and insights generation engine 120 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 124. Each game file 124 may include spatial event data and non-spatial event data. For example, spatial event data may correspond to raw data captured from a particular game or event by tracking system 102. Non-spatial event data may correspond to one or more variables describing the events occurring in a particular match without associated spatial information. For example, non-spatial event data may be representative of play-by-play data for a given event. In some embodiments, non-spatial event data may be derived from spatial event data. For example, pre-processing agent 116 may be configured to parse the spatial event data to derive shot attempt information. In some embodiments, non-spatial event data may be derived independently from spatial event data. For example, an administrator or entity associated with organization computing system may analyze each match to generate such non-spatial event data. As such, for purposes of this application, event data may correspond to spatial event data and non-spatial event data.

In some embodiments, each game file 124 may further include the current score at each time, t, during the match, the venue at which the match is played, the roster of each team, the minutes played by each team, and the stats associated with each team and each player.

Pre-processing agent 116 may be configured to process data retrieved from data store 118. For example, pre-processing agent 116 may be configured to generate one or more sets of information that may be used to train machine learning algorithms associated with insights generation engine 120. Pre-processing agent 116 may scan each of the one or more game files stored in data store 118 to identify one or more statistics corresponding to each specified data set, and generate each data set accordingly. For example, pre-processing agent 116 may scan each of the one or more game files in data store 118 to identify play-by-play data contained therein, and pull a variety of information associated with each play.

Insights generation engine 120 may be configured to generate live (or near-live) insights based on play-by-play data. Insights generation engine 120 may include knowledge graph engine 126 and machine learning module 128.

Knowledge graph engine 126 may be configured to generate a knowledge structure utilized by insights generation engine 120. For example, knowledge graph engine 126 may be configured to construct a knowledge graph that consumes a stream of play-by-play data from live events and maintains up-to-date game, season, and career statistics for players, teams, coaches, venues, and organizing units (e.g., leagues, conferences, divisions, etc.). The knowledge graph generated by knowledge graph engine 126 may serve as the “source of truth” for the insights generated by insights generation engine 120. In some embodiments, one or more knowledge graphs 125 may be stored in data store 118.

In some embodiments, knowledge graph engine 126 may generate one or more knowledge graphs based on historical play-by-play data from various game files 124. For example, given play-by-play data in a historical game file, knowledge graph engine 126 may generate a knowledge graph. Such knowledge graph may be updated over a course of a season, a career, a decade, a team's life, and the like.

Generally, for a knowledge graph, a node (or entity) may correspond to nouns in a given play. For example, nodes may correspond to “Zion,” “Duke,” “Duke-UNC (ACC final),” “Luke Maye,” “UNC,” and the like. Edges (or relations) may correspond to verbs in a given play. For example, an edge between a Zion node and a Duke node may read “plays for.” In other words, Zion plays for Duke. Both nodes and edges may be configured to store arbitrary properties or facts. Generally, any fact that an end user wishes to return may be stored as a property on an edge or a node.

Knowledge graph engine 126 may continually update a given knowledge graph, in real-time (or near real-time) based on play-by-play or tracking information. For example, when a new play is received from a live event, knowledge graph engine 126 may update the statistics for all entities associated with that play and publish a list of nodes and edges that were affected.

In some embodiments, when a knowledge graph has been updated, knowledge graph engine 126 may interface, or communicate, with machine learning module 128. For example, knowledge graph engine 126 may trigger machine learning module 128 to execute a machine learning process that generates new insights or updates existing insights based on the most recent changes to a given knowledge graph. In some embodiments, machine learning module 128 may be configured to implement templates to generate the insights. The templates may include a deterministic definition of the output text. In some embodiments, the template may further include references to the statistics necessary to populate the insight.

In some embodiments, machine learning module 128 may be configured to identify insights that include descriptive stats. For example, machine learning module 128 may be configured to learn player and team level stats, whether a play or team is over/under-performing relative to a career/season/tournament, and the like. Using a particular example, an insight may be that RJ Barrett has 20 points so far, putting him on face for a season high. In another particular example, an insight may be: Duke only had 6 rebounds in the first half, compared to their first-half average of 12.

In some embodiments, machine learning module 128 may be configured to identify insights that correspond to streaks (e.g., X successes in a row). For example, machine learning module 128 may be configured to identify team level streaks (e.g., points, turnovers, rebounds, blocks, first downs, hits, doubles, goals, assists, etc.) and player-level streaks (e.g., points, turnovers, steals, assists, rebounds (offensive/defensive), catches, sacks, hits, etc.). In some embodiments, machine learning module 128 may be configured to identify insights that correspond to droughts (e.g., team points in last t-seconds is <average). In some embodiments, machine learning module 128 may be configured to identify insights that correspond to runs (e.g., team points-for in last t-seconds is <average and other team is in a drought).

In some embodiments, machine learning module 128 may be configured to identify when a team is hot/cold. For example, machine learning module 128 may be configured to identify an insight corresponding to a combination of offensive/defensive statistics is historically anomalous. In another example, machine learning module 128 may be configured to identify an insight corresponding to a combination of offensive/defensive statistics that is contributing to a high/low win probability.

Once the insights are generated, machine learning module 128 may further be configured to rank the insights based on how relevant or interesting they are to fans. In some embodiments, machine learning module 128 may utilize a multi-armed bandit approach to rank the insights. Machine learning module 128 may be configured to learn which insights are more or less interesting to fans, and rank those insights accordingly. In some embodiments, machine learning module 128 may be trained to rank insights in the following two ways. Those skilled in the art may recognize, however, that other training mechanisms may also be possible.

First, machine learning module 128 may be configured to learn how to rank insights based on a likelihood of occurrence. For example, insights provided during broadcasts often focus on identifying low probability events. As an extreme example, new records may represent events which have never happened before in a particular context, and so are low probability by definition. Machine learning module 128 may be configured to learn how to identify these insights by comparing performance of players and teams throughout a game to historical data. Machine learning module 128 may then estimate the probability of a particular event happening, and rank those “rarer” events more highly than those more common events. For example, for each game, machine learning module 128 may be configured to generate a “p-value,” which corresponds to a probability of a statistics or one more extreme. Using this p-value, machine learning module 128 may generate a nearest neighbors model, and calculate a local outlier factor.

Second, machine learning module 128 may be configured to learn how to rank insights based on an impact on the event (or game). For example, another key point of interest for sports fans is knowing what plays or stats have had the largest impact on the game or season so far. By building predictive models of in-game win probabilities and season win-loss records, machine learning module 128 may be able to estimate how much of an impact various statistics have had on the team's overall performance and rank more impactful stats higher. For example, machine learning module 128 may score a team-level insight by building a linear win probability module, e.g., score=coeff*(actual stat−expected stat). In another example, machine learning module 128 may be configured to score player level insights.

For example, in operation, machine learning module 128 may use a Bayesian model to estimate the expectation for a player's performance in a game. Machine learning module 128 may be configured to continually update estimate throughout the game. In some embodiments, machine learning module 128 may use Kullback-Leibler distance between the prior and posterior to generate a score for that insight. In another example, machine learning module 128 may use a random forest regressor to generate a win probability at every point in the game, and to look for large swings in win probability, since those events were likely more interesting. In some embodiments Local Interpretable Model-Agnostic Explanations (LIME) may also be used to attribute the swing to a particular statistic. In another example, machine learning module 128 may apply one or more heuristics to determine interestingness that would look for very high or low percentile stats, long streaks of certain events/stats, or statistics over a certain threshold.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 132. Application 132 may be representative of a web browser that allows access to a website or a stand-alone application. Client device 108 may access application 132 to access one or more functionalities of organization computing system 104. Client device 108 may communicate over network 105 to request a webpage, for example, from web client application server 114 of organization computing system 104. For example, client device 108 may be configured to execute application 132 to access content managed by web client application server 114. The content that is displayed to client device 108 may be transmitted from web client application server 114 to client device 108, and subsequently processed by application 132 for display through a graphical user interface (GUI) of client device 108. For example, client device 108 may access application 132 to view one or more insights generated by insights generation engine 120.

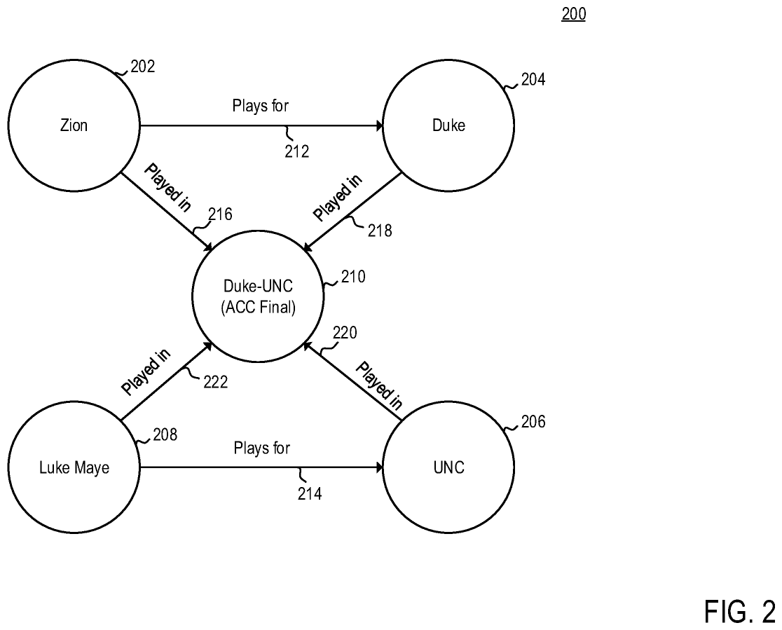

FIG. 2 is a block diagram illustrating an exemplary knowledge graph 200, according to example embodiments. As illustrated, knowledge graph 200 may include one or more nodes 202, 204, 206, 208 and 210 and one or more edges 212, 214, 216, 218, 220, and 222. As discussed above, each node may represent a given noun or entity. For example, node 202 may refer to Zion; node 204 may refer to Duke; node 206 may refer to UNC; node 208 may refer to Duke; node 210 may refer to Duke-UNC (ACC final). Edge 212 may extend from node 202 to node 204. For example, edge 212 may include information stored thereon, which corresponds to the fact that Zion plays for Duke. Edge 214 may extend from node 208 and node 206. For example, edge 214 may include information stored thereon, which corresponds to the fact that Luke Maye plays for UNC. Edge 216 may extend from node 202 to node 210. For example, edge 216 may include information stored thereon, which corresponds to the fact that Zion played in the Duke-UNC (ACC final) game. Edge 218 may extend from node 204 to node 210. For example, edge 218 may include information stored thereon, which corresponds to the fact that Duke was a team that played in the Duke-UNC (ACC final) game. Edge 220 may extend from node 206 to 210. For example, edge 220 may include information stored thereon, which correspond to the fact that UNC was a team that played in the Duke-UNC (ACC final) game. Edge 222 may extend between node 208 and node 210. For example, edge 222 may include information stored thereon, which correspond to the fact that Luke Maye played in the Duke-UNC (ACC Final) game.

As those skilled in the art recognize, some aspects of knowledge graph 200 may have been generated prior to the Duke-UNC ACC final. For example, node 202, node 204, node 206, and node 208 may have existed prior to the Duke-UNC ACC final. In other words, prior to the game in question, knowledge graph engine 126 may have previously created node 202 directed to Zion, node 204 directed to Duke, node 206 directed to UNC, and node 208 directed to Luke Maye. Accordingly, knowledge graph engine 126 may have previously drawn edge 212 between node 202 and 204 and edge 214 between node 208 and node 206.

At some point when Duke and UNC were announced as contestants in the ACC final, knowledge graph engine 126 may have updated knowledge graph 200 to include edges 216, 218, 220, and 222. During the course of the game, insights generation engine 120 may receive real-time (or near real-time) play-by-play information. Assuming, for example, that Zion converts a two-point field goal during a given play, knowledge graph engine 126 may update edge 216 to include said information. In other words, edge 216 may be updated throughout the event (e.g., in real-time, near real-time, periodically, etc.) to reflect Zion's box score (i.e., game statistics).

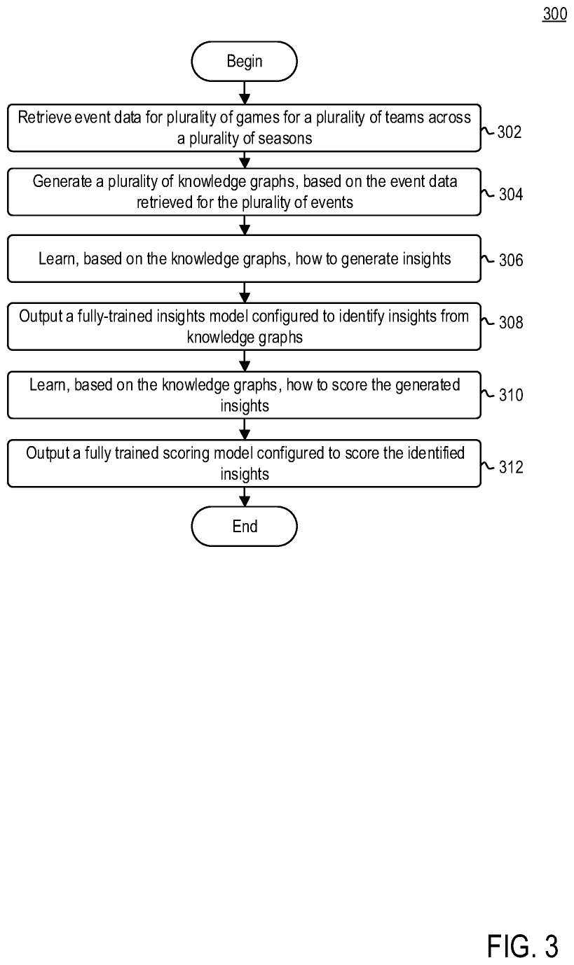

FIG. 3 is a flow diagram illustrating a method 300 of generating a fully trained insights generation and scoring models, according to example embodiments. Method 300 may begin at step 302.

At step 302, insights generation engine 120 may retrieve event data for a plurality of events. For example, insights generation engine 120 may retrieve play-by-play events for plurality of games for a plurality of teams across a plurality of seasons. Play-by-play data may include information, such as, but not limited to players on the field of play for each play, the starting time of each play (e.g., first quarter, nine minutes; first quarter, three minutes, third down and five yards), the end time of each play (e.g., second half, twelve minutes), the duration of each play, which team has possession, the box score statistics associated with the play (e.g., who shot the ball, was the field goal attempt successful, if successful, who (if anyone) assisted, who turned the ball over, who forced the turnover, etc.), and the like.

At step 304, knowledge graph engine 126 may generate a plurality of knowledge graphs, based on the event data retrieved for the plurality of events. For example, knowledge graph engine 126 may build a repository of historic knowledge graphs reflecting events across a subset of seasons. Using a specific example, knowledge graph engine 126 may receive play-by-play information for each Division 1 NCAA men's basketball game from the past twenty-five years. Given this play-by-play data, knowledge graph engine 126 may generate a plurality of knowledge graphs, in accordance with the methodologies discussed above.

As step 306, machine learning module 128 may be configured to learn, based on the knowledge graphs, how to generate insights. For example, machine learning module 128 may execute a machine learning process to generate an insights model that learns how to generates new insights or updates existing insights based on the most recent changes to a given knowledge graph, and score those insights accordingly. During the training process, machine learning module 128 may utilize a subset of information in the historical knowledge graphs. For example, pre-processing agent 116 may generate a plurality of training sets to be implemented by machine learning module 128 during training.

In some embodiments, machine learning module 128 may be configured to implement templates in learning how to generate the insights. The templates may include a deterministic definition of the output text. In some embodiments, the template may further include references to the statistics necessary to populate the insight.

In some embodiments, machine learning module 128 may be configured to learn how to identify insights that include descriptive stats. For example, machine learning module 128 may be configured to learn player and team level stats, whether a player or team is over/under-performing relative to a career/season/tournament, and the like. In some embodiments, machine learning module 128 may be configured to learn to identify insights that correspond to streaks (e.g., X successes in a row). For example, machine learning module 128 may be configured to learn to identify team level streaks (e.g., points, turnovers, rebounds, blocks, first downs, hits, doubles, goals, assists, etc.) and player-level streaks (e.g., points, turnovers, steals, assists, rebounds (offensive/defensive), catches, sacks, hits, etc.). In some embodiments, machine learning module 128 may be configured to learn to identify insights that correspond to droughts (e.g., team points in last t-seconds is <average). In some embodiments, machine learning module 128 may be configured to learn to identify insights that correspond to runs (e.g., team points-for in last t-seconds is <average and other team is in a drought).

In some embodiments, machine learning module 128 may be configured to learn to identify when a team is hot/cold. For example, machine learning module 128 may be configured to learn to identify an insight corresponding to a combination of offensive/defensive statistics is historically anomalous. In another example, machine learning module 128 may be configured to learn to identify an insight corresponding to a combination of offensive/defensive statistics that is contributing to a high/low win probability.

At step 308, machine learning module 128 may output a fully-trained insights model configured to identify insights from knowledge graphs.

At step 310, machine learning module 128 may be configured to learn, based on the knowledge graphs, how to score the generated insights. Once the insights are generated, machine learning module 128 may further be configured to generate a scoring model that rank the insights based on how relevant or interesting they are to fans. For example, machine learning module 128 may be configured to learn which insights are more or less interesting to fans, and rank those insights accordingly. In some embodiments, machine learning module 128 may be trained to rank insights in the following two ways. Those skilled in the art may recognize, however, that other training mechanisms may also be possible.

First, machine learning module 128 may be configured to learn how to rank insights based on a likelihood of occurrence. For example, insights provided during broadcasts often focus on identifying low probability events. As an extreme example, new records may represent events which have never happened before in a particular context, and so are low probability by definition. Machine learning module 128 may be configured to learn how to identify these insights by comparing performance of players and teams throughout a game to historical data. Machine learning module 128 may then learn to estimate the probability of a particular event happening, and rank those “rarer” events more highly than those more common events. For example, for each game, machine learning module 128 may be configured to generate a “p-value,” which corresponds to a probability of a statistics or one more extreme. Using this p-value, machine learning module 128 may generate a nearest neighbors model, and calculate a local outlier factor.

Second, machine learning module 128 may be configured to learn how to rank insights based on an impact on the event (or game). For example, another key point of interest for sports fans is knowing what plays or stats have had the largest impact on the game or season so far. By building predictive models of in-game win probabilities and season win-loss records, machine learning module 128 may be able to estimate how much of an impact various statistics have had on the team's overall performance and rank more impactful stats higher. For example, machine learning module 128 may score a team-level insight by building a linear win probability module, e.g., score=coeff*(actual stat—expected stat). In another example, machine learning module 128 may be configured to score player level insights. At step 312, machine learning module 128 may output a fully trained scoring model configured to score the identified insights.

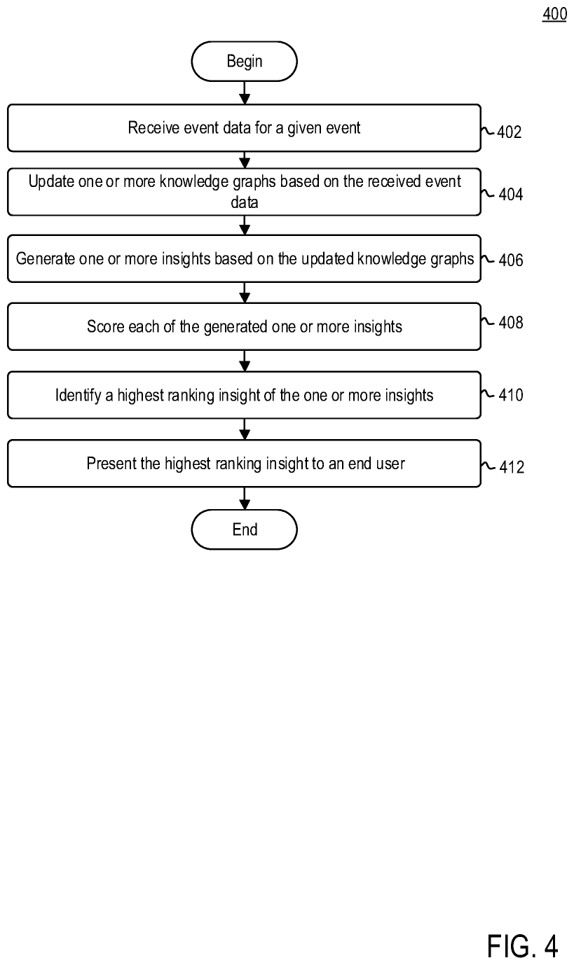

FIG. 4 is a flow diagram illustrating a method 400 of generating, scoring, and presenting an insight to an end user, according to example embodiments. Method 400 may begin at step 402.

At step 402, insights generation engine 120 may receive event data for a given event. The event data may include play-by-play data. Such play-by-play data may include information, such as, but not limited to players on the field of play for each play, the starting time of each play (e.g., first quarter, nine minutes; first quarter, three minutes, third down and five yards), the end time of each play (e.g., second half, twelve minutes), the duration of each play, which team has possession, the box score statistics associated with the play (e.g., who shot the ball, was the field goal attempt successful, if successful, who (if anyone) assisted, who turned the ball over, who forced the turnover, etc.), and the like. In some embodiments, play-by-play data may be received in real-time (or near real-time). In some embodiments, play-by-play data may be received periodically in batches.

At step 404, insights generation engine 120 may update one or more knowledge graphs based on the received play-by-play data. For example, knowledge graph engine 126 may parse the play-by-play data to determine whether a new edge or node is to be added to a knowledge graph. If, for example, a new edge or node is to be added to a knowledge graph (e.g., a new player enters the game for the first time), knowledge graph engine 126 may update a knowledge graph corresponding to the event accordingly. In another example, knowledge graph engine 126 may parse the play-by-play data to determine whether an edge or node is to be updated. Continuing with an example discussed above, when Zion records a rebound, knowledge graph engine 126 may update an edge extending between Zion and the event to include such rebound.

At step 406, insights generation engine 120 may generate one or more insights based on the updated knowledge graphs. For example, using insights model, insights generation engine 120 to generate one or more insights based on the updated knowledge graphs. In some embodiments, insights model may utilize templates to generate the insights. The templates may include a deterministic definition of the output text. In some embodiments, the template may further include references to the statistics necessary to populate the insight.

In some embodiments, the insights may include descriptive stats. For example, the descriptive steps may include player and team level stats, whether a play or team is over/under-performing relative to a career/season/tournament, and the like. In some embodiments, the insights may include streak-based statistics, such as team level streaks (e.g., points, turnovers, rebounds, blocks, first downs, hits, doubles, goals, assists, etc.) and player-level streaks (e.g., points, turnovers, steals, assists, rebounds (offensive/defensive), catches, sacks, hits, etc.). In some embodiments, the insights may include droughts information (e.g., team points in last t-seconds is <average). In some embodiments, insights may include runs information (e.g., team points-for in last t-seconds is <average and other team is in a drought). In some embodiments, an insight may include a combination of offensive/defensive statistics is historically anomalous. In some embodiments, an insight may include a combination of offensive/defensive statistics that is contributing to a high/low win probability.

At step 408, insights generation engine 120 may score the one or more insights. For example, using scoring model, insights generation engine 120 may score insights based on, for example, those insights are more or less interesting to fans, and rank those insights accordingly. In some embodiments, scoring model may score insights based on a likelihood of occurrence. Scoring model may identify these insights by comparing performance of players and teams throughout a game to historical data. Scoring model may estimate the probability of a particular event happening, and rank those “rarer” events more highly than those more common events. In some embodiments, scoring model may rank insights based on an impact on the event (or game).

At step 410, insights generation engine 120 may identify a highest ranking insight. For example, based on the previously generated insights scores, insights generation engine 120 may identify the highest ranking insight to present to users.

At step 412, insights generation engine 120 may present the highest ranking insight to users. In some embodiments, presenting the highest ranking insight includes providing the insight to a broadcaster via a display. In some embodiments, presenting the highest ranking insight includes prompting a computing device to display the insight.

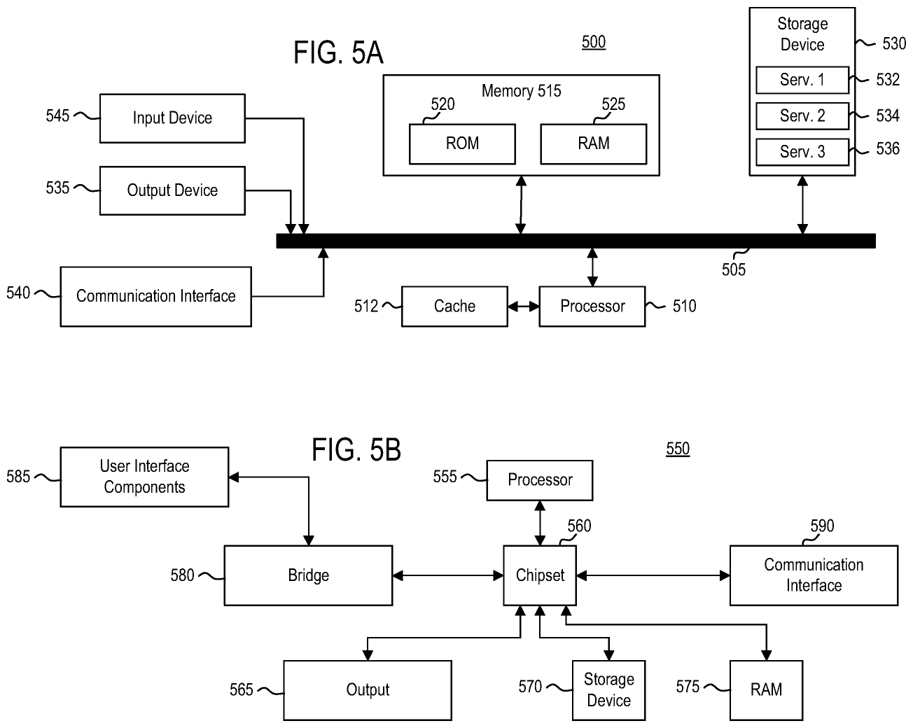

FIG. 5A illustrates a system bus architecture of computing system 500, according to example embodiments. Computing system 500 may be representative of at least a portion of organization computing system 104. One or more components of computing system 500 may be in electrical communication with each other using a bus 505. Computing system 500 may include a processing unit (CPU or processor) 510 and a system bus 505 that couples various system components including the system memory 515, such as read only memory (ROM) 520 and random access memory (RAM) 525, to processor 510. Computing system 500 may include a cache of high-speed memory connected directly with, in close proximity to, or integrated as part of processor 510. Computing system 500 may copy data from memory 515 and/or storage device 530 to cache 512 for quick access by processor 510. In this way, cache 512 may provide a performance boost that avoids processor 510 delays while waiting for data. These and other modules may control or be configured to control processor 510 to perform various actions. Other system memory 515 may be available for use as well. Memory 515 may include multiple different types of memory with different performance characteristics. Processor 510 may include any general purpose processor and a hardware module or software module, such as service 1 532, service 2 534, and service 3 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction with the computing system 500, an input device 545 may represent any number of input mechanisms, such as a microphone for speech, a touch-sensitive screen for gesture or graphical input, keyboard, mouse, motion input, speech and so forth. An output device 535 (e.g., display) may also be one or more of a number of output mechanisms known to those of skill in the art. In some instances, multimodal systems may enable a user to provide multiple types of input to communicate with computing system 500. Communications interface 540 may generally govern and manage the user input and system output. There is no restriction on operating on any particular hardware arrangement and therefore the basic features here may easily be substituted for improved hardware or firmware arrangements as they are developed.

Storage device 530 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 525, read only memory (ROM) 520, and hybrids thereof.

Storage device 530 may include services 532, 534, and 536 for controlling the processor 510. Other hardware or software modules are contemplated. Storage device 530 may be connected to system bus 505. In one aspect, a hardware module that performs a particular function may include the software component stored in a computer-readable medium in connection with the necessary hardware components, such as processor 510, bus 505, output device 535, and so forth, to carry out the function.

FIG. 5B illustrates a computer system 550 having a chipset architecture that may represent at least a portion of organization computing system 104. Computer system 550 may be an example of computer hardware, software, and firmware that may be used to implement the disclosed technology. System 550 may include a processor 555, representative of any number of physically and/or logically distinct resources capable of executing software, firmware, and hardware configured to perform identified computations. Processor 555 may communicate with a chipset 560 that may control input to and output from processor 555. In this example, chipset 560 outputs information to output 565, such as a display, and may read and write information to storage device 570, which may include magnetic media, and solid state media, for example. Chipset 560 may also read data from and write data to RAM 575. A bridge 580 for interfacing with a variety of user interface components 585 may be provided for interfacing with chipset 560. Such user interface components 585 may include a keyboard, a microphone, touch detection and processing circuitry, a pointing device, such as a mouse, and so on. In general, inputs to system 550 may come from any of a variety of sources, machine generated and/or human generated.

Chipset 560 may also interface with one or more communication interfaces 590 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 555 analyzing data stored in storage device 570 or RAM 575. Further, the machine may receive inputs from a user through user interface components 585 and execute appropriate functions, such as browsing functions by interpreting these inputs using processor 555.

It may be appreciated that example systems 500 and 550 may have more than one processor 510 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
receiving, by a computing system, event data comprising play-by-play information for an event;
accessing, by the computing system, a database comprising a knowledge graph related to the event, wherein the knowledge graph comprises:
a plurality of nodes, wherein each node of the plurality of nodes represents a player or a team involved in the event, and
a plurality of edges connecting nodes of the plurality of nodes, wherein each edge of the plurality of edges represents an action performed in the event;
updating, by the computing system, the knowledge graph based on the play-by-play information;
generating, by the computing system, via a first machine learning model, one or more insights based on the updated knowledge graph;
scoring, by the computing system, via a second machine learning model, a score for each of the one or more insights; and
presenting, by the computing system, a highest ranking insight of the one or more insights to one or more end users.

2. The method of claim 1, further comprising:
generating, by the computing system, the first machine learning model by:
generating a plurality of training data sets based on a plurality of historical knowledge graphs; and
learning, by the first machine learning model, the one or more insights based on the plurality of historical knowledge graphs via templates comprising a deterministic output of descriptive text.

3. The method of claim 2, wherein learning, by the first machine learning model, the one or more insights based on the plurality of historical knowledge graphs via the templates comprising the deterministic output of the descriptive text comprises:
learning to identify insights that correspond to team-level or play-level streaks.

4. The method of claim 2, further comprising:
generating, by the computing system, the second machine learning model by learning, by the second machine learning model, a score for each of the one or more insights by identifying a relevance of each insight compared to other insights.

5. The method of claim 4, wherein learning, by the second machine learning model, the score for each of the one or more insights by identifying the relevance of each insight compared to other insights comprises:
learning to score insights based on a likelihood of occurrence of a particular statistic.

6. The method of claim 4, wherein learning, by the second machine learning model, the score for each of the one or more insights by identifying the relevance of each insight compared to other insights comprises:
learning to score insights based on a particular statistic's impact on a corresponding event.

7. The method of claim 1, wherein presenting, by the computing system, the highest ranking insight of the one or more insights to the one or more end users, comprises:
interfacing with a client device and prompting the client device to display the highest ranking insight on a display associated therewith.

8. A system, comprising:
a processor; and
a memory having programming instructions stored thereon, which, when executed by the processor, causes the system to perform operations, comprising:
receiving event data comprising play-by-play information for an event;
accessing a database comprising a knowledge graph related to the event, wherein the knowledge graph comprises:
a plurality of nodes, wherein each node of the plurality of nodes represents a player or a team involved in the event, and
a plurality of edges connecting nodes of the plurality of nodes, wherein each edge of the plurality of edges represents an action performed in the event;
updating the knowledge graph based on the play-by-play information;
generating via a first machine learning model, one or more insights based on the updated knowledge graph;
scoring, via a second machine learning model, a score for each of the one or more insights; and
presenting a highest ranking insight of the one or more insights to one or more end users.

9. The system of claim 8, wherein the operations further comprise:
generating the first machine learning model by:
generating a plurality of training data sets based on a plurality of historical knowledge graphs; and
learning, by the first machine learning model, the one or more insights based on the plurality of historical knowledge graphs via templates comprising a deterministic output of descriptive text.

10. The system of claim 9, wherein learning, by the first machine learning model, the one or more insights based on the plurality of historical knowledge graphs via the templates comprising the deterministic output of the descriptive text comprises:
learning to identify insights that correspond to team-level or play-level streaks.

11. The system of claim 9, further comprising:
generating the second machine learning model by learning, by the second machine learning model, a score for each of the one or more insights by identifying a relevance of each insight compared to other insights.

12. The system of claim 11, wherein learning, by the second machine learning model, the score for each of the one or more insights by identifying the relevance of each insight compared to other insights comprises:
learning to score insights based on a likelihood of occurrence of a particular statistic.

13. The system of claim 11, wherein learning, by the second machine learning model, the score for each of the one or more insights by identifying the relevance of each insight compared to other insights comprises:
learning to score insights based on a particular statistic's impact on a corresponding event.

14. The system of claim 9, wherein presenting the highest ranking insight of the one or more insights to the one or more end users, comprises:
interfacing with a client device and prompting the client device to display the highest ranking insight on a display associated therewith.

15. A non-transitory computer readable medium including one or more sequences of instructions that, when executed by one or more processors, causes a computing system to perform operations comprising:
receiving, by the computing system, event data comprising play-by-play information for an event;
accessing, by the computing system, a database comprising a knowledge graph related to the event, wherein the knowledge graph comprises:
a plurality of nodes, wherein each node of the plurality of nodes represents a player or a team involved in the event, and
a plurality of edges connecting nodes of the plurality of nodes, wherein each edge of the plurality of edges represents an action performed in the event;
updating, by the computing system, the knowledge graph based on the play-by-play information;
generating, by the computing system, via a first machine learning model, one or more insights based on the updated knowledge graph;
scoring, by the computing system, via a second machine learning model, a score for each of the one or more insights; and
presenting, by the computing system, a highest ranking insight of the one or more insights to one or more end users.

16. The non-transitory computer readable medium of claim 15, further comprising:
generating, by the computing system, the first machine learning model by:
generating a plurality of training data sets based on a plurality of historical knowledge graphs; and
learning, by the first machine learning model, one or more insights based on the plurality of historical knowledge graphs via templates comprising a deterministic output of descriptive text.

17. The non-transitory computer readable medium of claim 16, wherein learning, by the first machine learning model, the one or more insights based on the plurality of historical knowledge graphs via the templates comprising the deterministic output of the descriptive text comprises:
learning to identify insights that correspond to team-level or play-level streaks.

18. The non-transitory computer readable medium of claim 16, further comprising:
generating, by the computing system, the second machine learning model by learning, by the second machine learning model, a score for each of the one or more insights by identifying a relevance of each insight compared to other insights.

19. The non-transitory computer readable medium of claim 18, wherein learning, by the second machine learning model, the score for each of the one or more insights by identifying the relevance of each insight compared to other insights comprises:
learning to score insights based on a likelihood of occurrence of a particular statistic.

20. The non-transitory computer readable medium of claim 18, wherein learning, by the second machine learning model, the score for each of the one or more insights by identifying the relevance of each insight compared to other insights comprises:
learning to score insights based on a particular statistic's impact on a corresponding event.
